(19) United States
(12) Patent Application Publication
(10) Pub. No.: US 2013/0017449 A1
(43) Pub. Date: Jan. 17, 2013

(54) POSITIVE-ELECTRODE ACTIVE MATERIAL FOR LITHIUM-ION SECONDARY BATTERY AND LITHIUM-ION SECONDARY BATTERY

(71) Applicants: Naoto Yasuda, Kariya-shi (JP); Hitotoshi Murase, Kariya-shi (JP); Ryota Isomura, Kariya-shi (JP); Toru Abe, Kariya-shi (JP)

(72) Inventors: Naoto Yasuda, Kariya-shi (JP); Hitotoshi Murase, Kariya-shi (JP); Ryota Isomura, Kariya-shi (JP); Toru Abe, Kariya-shi (JP)

(73) Assignee: KABUSHIKI KAISHA TOYOTA JIDOSHOKKI, Kariya-shi, Aichi (JP)

(21) Appl. No.: 13/637,868

(22) PCT Filed: Apr. 4, 2011
(86) PCT No.: PCT/JP2011/002006

§ 371 Date: Sep. 27, 2012

(30) Foreign Application Priority Data
Apr. 23, 2010 (JP) 2010-099577

(51) Int. Cl. H01M 4/36; H01M 4/583; H01B 1/00; H01M 4/525; H01M 4/505; H01M 4/485; H01M 4/02; H01M 4/38

(52) U.S. Cl. 429/231.8; 429/209; 429/231.95; 252/182.1; 252/500

(57) ABSTRACT

The present invention is characterized in that it is a positive-electrode active material for lithium-ion secondary battery, the positive-electrode active material being capable of absorbing and releasing lithium; it includes the following at least: a first compound exhibiting an irreversible capacity; and a second compound being capable of absorbing more lithium than an amount of lithium that has been released at the time of first-round charging; and it exhibits an irreversible capacity decreasing as a whole of active material.

An irreversible capacity of the resulting positive-electrode active material can be reduced by combining the specific compounds to use.

### TECHNICAL FIELD

The present invention is one which relates to a positive-electrode active material that is employed as a positive-electrode material for lithium-ion secondary battery, and to a lithium-ion secondary battery that uses that positive-electrode active material.

### BACKGROUND ART

Recently, as being accompanied by the developments of portable electronic devices such as cellular phones and notebook-size personal computers, or as being accompanied by electric automobiles being put into practical use, and the like, small-sized, lightweight and high-capacity secondary batteries have been required. At present, as for high-capacity secondary batteries meeting these demands, non-aqueous secondary batteries have been commercialized, non-aqueous secondary batteries in which lithium cobaltate (e.g., LiCoO₂) and the carbon-system materials are used as the positive-electrode material and negative-electrode material, respectively. Since such a non-aqueous secondary battery exhibits a high energy density, and since it is possible to intend to make it downsize and lightweight, its employment as a power source has been attracting attention in a wide variety of fields. However, since LiCoO₂ is produced with use of Co, one of rare metals, as the raw material, it has been expected that its scarcity as the resource would grow worse from now on. In addition, since Co is expensive, and since its price fluctuates greatly, it has been desired to develop positive-electrode materials that are inexpensive as well as whose supply is stable.

Hence, it has been regarded promising to employ lithium-manganese-oxide-system composite oxides whose constituent elements are inexpensive in terms of the prices as well as which include stably-supplied manganese (Mn) in their essential compositions. Among them, a substance, namely, Li₂MnO₃ that comprises tetravalent manganese ions but does not include any trivalent manganese ions making a cause of the manganese elution upon charging and discharging, has been attracting attention. Although it has been believed so far that it is impossible to charge and discharge Li₂MnO₃, it has come to find out that it is possible to charge and discharge it by means of charging it up to 4.8 V, according to recent studies. However, it is needed to further improve Li₂MnO₃ with regard to the charging/discharging characteristics.

In order to improve the charging/discharging characteristics, it has been done actively to develop xLi₂MnO₃.(1-x)LiMO₂ (where 0<“x”≦1), one of solid solutions between Li₂MnO₃ and LiMO₂ (where “M” is a transition metal element). However, upon employing a secondary battery including Li₂MnO₃ as the positive-electrode active material, it is needed to activate the positive-electrode active material at the time of first-round charging. Since the activation is accompanied by a large irreversible capacity, ions having moved to the counter electrode do not come back, and so there is such a problem that charging/discharging balance between the positive electrode and the negative electrode becomes imbalanced. With regard to the mechanism of this activation and to an obtainable capacity by means of the activation, it is the present situation that they have not been clearly clarified yet (see Non-patent Literature No. 1).

As some of the examples, Patent Literature No. 1, and Patent Literature No. 2 set forth lithium-ion secondary batteries using positive-electrode active materials that include Li₂MnO₃. Patent Literature No. 1 sets forth a lithium-ion secondary that uses 0.6Li₂MnO₃.0.4LiMn₂O₄ as the positive-electrode active material. Moreover, Patent Literature No. 2 sets forth a lithium-ion secondary battery that uses a solid solution between Li₂MnO₃ and LiMn_{0.5}Ni_{0.5}O₂, or another solid solution between Li₂MnO₃ and LiMn_{0.33}Ni_{0.33}CO_{0.33}O₂, as the positive-electrode active material.

### RELATED TECHNICAL LITERATURE

### Patent Literature

Patent Literature No. 1: Published Japanese Translation of PCT Application Gazette No. 2008-511960; and

Patent Literature No. 2: Japanese Unexamined Patent Publication (KOKAI) Gazette No. 2009-9753

### Non-Patent Literature

Non-patent Literature No. 1: Komaba et al., “Li₂MnO₃-stabilized LiMO₂ (M=Mn, Ni, Co) Electrodes for Lithium-ion Batteries,” Journal of Materials Chemistry 17, (2007), pp. 3, 112-3, 125

### SUMMARY OF THE INVENTION

### Assignment to be Solved by the Invention

FIG. 6 in Patent Literature No. 1 shows the initial charging/discharging potential profile of a lithium-ion secondary battery that used 0.6Li₂MnO₃.0.4LiMn₂O₄ as the positive-electrode active material. This lithium-ion secondary battery used a counter electrode (i.e., a negative electrode) that comprised metallic lithium. Consequently, it is unclear whether lithium to be absorbed into the positive-electrode active material by means of discharging is the lithium, which has been released from the positive electrode by means of charging immediately before the discharging, or the lithium, which has been present in the counter electrode. That is, it is unclear from the descriptions in Patent Literature No. 1 to which destinations lithium, which has been released from Li₂MnO₃ by first-round charging and which is equivalent to an irreversible capacity, goes.

In Patent Literature No. 2, a solid solution, which includes LiMn_{0.5}Ni_{0.5}O₂ or LiMn_{0.22}Ni_{0.22}CO_{0.22}O₂ together with Li₂MnO₂, is employed as the positive-electrode active material. This positive-electrode active material further includes manganese dioxide. The resulting initial charging/discharging efficiency is upgraded by combining the solid solution under discharged condition and manganese dioxide under charged condition to use them as the positive-electrode active material. However, the role of LiMn_{0.5}Ni_{0.5}O₂ and LiMn_{0.33}Ni_{0.33}CO_{0.33}O₂ is not clear at all.

That is, since Patent Literature Nos. 1 and 2 do not at all involve such an idea as reducing the irreversible capacity that Li₂MnO₃ exhibits, a specific method for reducing the irreversible capacity has been desired. Hence, the present invention aims at providing a positive-electrode active material for lithium-ion secondary battery, and a lithium-ion secondary battery, positive-electrode active material and lithium-ion secondary battery in which specific compounds are combined to use in order to reduce the positive-electrode active material's irreversible capacity.

### Means for Solving the Assignment

Among battery active materials, compounds have been available, compounds in which an amount of lithium being absorbed by means of discharging, which takes place subsequently, becomes greater than another amount of lithium, which has been released by means of first-round charging, by undergoing discharging down to a voltage that is much lower than another voltage at the start of charging. The present inventors found out newly that it is possible to reduce an irreversible capacity in positive electrode as a whole by using such a compound along with a positive-electrode active material, such as Li₂MnO₃, which exhibits an irreversible capacity. And, the present inventors arrived at completing various inventions being described hereinafter by developing this accomplishment.

Specifically, a positive-electrode active material for lithium-ion secondary battery according to the present invention is characterized in that:

it is a positive-electrode active material for lithium-ion secondary battery, the positive-electrode active material being capable of absorbing and releasing lithium;

it includes the following at least: a first compound exhibiting an irreversible capacity; and a second compound being capable of absorbing more lithium than an amount of lithium that has been released at the time of first-round charging; and

it exhibits an irreversible capacity decreasing as a whole of active material.

As having been explained already, when Li₂MnO₃, or the like, is used in a positive electrode independently as the positive-electrode active material, some of Li, which have migrated to the counter electrode upon first-round charging, make an irreversible capacity because they do not come back to the positive electrode. It has been known that, in lithium-ion secondary batteries, the charging/discharging balance between the positive electrode and the negative electrode has got worse in subsequent charging and discharging operations because of the irreversible capacity. Therefore, if it is possible to have the positive electrode absorb lithium, which has been released at first-round charging, again at next-round discharging, the irreversible capacity can be relieved, and so the charging/discharging balance between the positive electrode and the negative electrode can be kept in a well balanced manner.

Hence, in the positive-electrode active material for lithium-ion secondary battery according to the present invention, a compound (i.e., a second compound), which is capable of absorbing more lithium than an amount of lithium that has been released at the time of first-round charging, namely, which is capable of including lithium in a much greater amount than its composition in the initial state (i.e., before undergoing first-round charging), is used together with another compound (i.e., a first compound), which exhibits an irreversible capacity. As a result, even when the first compound does not change at all in the irreversible capacity, an irreversible capacity as a whole of positive-electrode active material can be relieved or relaxed by means of the presence of the second compound. This mechanism will be explained using FIG. 8.

FIG. 8 illustrates an example of the positive-electrode active material for lithium-ion secondary battery according to the present invention schematically. In FIG. 8, the marks, and ∘, designate lithium sites; the marks, , specify a state in which a lithium ion exists, respectively; and the marks, ∘, specify a state in which no lithium ion exists, respectively. By means of charging, lithium migrates from a positive electrode in the initial state to a negative electrode. When carrying out discharging subsequently, since the first compound exhibits an irreversible capacity, it is not possible for the first compound to absorb lithium in all of the sites. However, since the second compound is capable of absorbing more lithium than it does in the initial state, it can absorb even lithium that does not come back to the first compound. Consequently, it follows that an irreversible capacity as an active material as a whole comes to be reduced. As illustrated in FIG. 8, when the second compound has room or allowance for absorbing lithium sufficiently against the irreversible capacity, it becomes feasible theoretically to have the positive electrode absorb lithium, which has once migrated to the negative electrode, as much as its total amount virtually.

Note that, when metallic lithium is used in the counter electrode, it is difficult to identify lithium, which has come back to the positive electrode by means of discharging, whether it is lithium, which has been released from the positive electrode by first-round charging, or it is lithium, which has been present in the counter electrode originally. Hence, the present inventors verified the present invention using a counter electrode that does not include any Li like the carbon-system materials, for instance, thereby ascertaining the fact that Li hardly exists in the counter electrode after discharging and the irreversible capacity of the first compound can be relieved or relaxed as a whole by means of the second compound. That is, it is preferable that the positive-electrode active material for lithium-ion secondary battery according to the present invention can absorb, of lithium that has been released at the time of first-round charging, at least some of the lithium, which is equivalent to the irreversible capacity of said first compound, at the time of subsequent discharging. In actuality, however, since lithium having been released from the first compound does not at all come back to the first compound and lithium having been released from the second compound does not at all come back to the second compound, the phrase, “the lithium, which is equivalent to the irreversible capacity of the first compound,” is not necessarily meant to indicate only the lithium that has been released from the first compound even when it is lithium that has been released from the positive-electrode active material.

For reference, LiMn_{0.5}Ni_{0.5}O₂ and LiMn_{0.33}Ni_{0.33}Co_{0.33}O₂, which are set forth in Patent Literature No. 2, are also capable of absorbing more lithium than they do in the initial state. However, it is needed to carry out discharging down to a lower potential than those usual or common potentials in order that these compounds absorb more lithium than they do in the initial state. However, in Patent Literature No. 2, the discharging operation is carried out only down to 2 V with respect to the potential of lithium metal as can be apparent from its FIG. 7, no irreversible capacity can be relieved or relaxed as illustrated in FIG. 8 of the present application. In addition, since Patent Literature No. 2 is directed to such an invention whose purpose is to have positive-electrode active materials under charged conditions absorb the irreversible capacity of Li₂MnO₃ at the stage of constituting batteries, it differs from the present invention fundamentally in terms of the gist.

### Effect of the Invention

Even when a compound exhibits an irreversible capacity, it is possible to reduce that irreversible capacity as a whole of positive-electrode active material by means of combining it with a specific compound to use these as the positive-electrode active material.

### BRIEF DESCRIPTION OF THE DRAWINGS

FIG. 1 is a graph that illustrates charging/discharging characteristics of a lithium-ion secondary battery in which Li₂NiTiO₄ exhibiting an irreversible capacity was used as the positive-electrode active material;

FIG. 2 is a graph that illustrates charging/discharging characteristics of a lithium-ion secondary battery in which Li₂MnO₃ exhibiting an irreversible capacity was used as the positive-electrode active material;

FIG. 3 is a graph that illustrates charging/discharging characteristics of a lithium-ion secondary battery in which LiMn₂O₄ being capable of absorbing more Li than it did in the initial state was used as the positive-electrode active material;

FIG. 4 is a graph that illustrates charging/discharging characteristics of a lithium-ion secondary battery in which LiMn_{0.33}Ni_{0.33}Co_{0.33}^{O}₂ being capable of absorbing more Li than it did in the initial state was used as the positive-electrode active material;

FIG. 5 is a graph that illustrates charging/discharging characteristics of a lithium-ion secondary battery in which a positive-electrode active material including Li₂NiTiO₄ and LiMn₂O₄ was used;

FIG. 6 is a graph that illustrates charging/discharging characteristics of a lithium-ion secondary battery in which a positive-electrode active material including Li₂MnO₃ and LiMn_{0.33}Ni_{0.33}CO_{0.33}O₂ was used;

FIG. 7 is a graph that illustrates charging/discharging characteristics of a lithium-ion secondary battery in which a positive-electrode active material including Li₂MnO₃ and LiMn₂O₄ was used; and

FIG. 8 is an explanatory diagram of a positive-electrode active material for lithium-ion secondary battery according to the present invention.

### MODE FOR CARRYING OUT THE INVENTION

Hereinafter, explanations will be made on some of the best modes for performing the positive-electrode active material for lithium-ion secondary battery and lithium-ion secondary battery according to the present invention. Note that, unless otherwise specified, ranges of numeric values, namely, “from ‘a’ to ‘b’” being set forth in the present description, involve the lower limit, “a,” and the upper limit, “b,” in those ranges. Moreover, the other ranges of numeric values are composable within those ranges of numeric values by arbitrarily combining values that are set forth in the present description.

### Positive-Electrode Active Material for Lithium-Ion Secondary Battery

A positive-electrode active material for lithium-ion secondary battery according to the present invention includes the following at least: a first compound exhibiting an irreversible capacity; and a second compound being capable of absorbing more lithium than an amount of lithium that has been released at the time of first-round charging.

The first compound is not limited especially as far as it is a compound that is one of compounds having been heretofore used conventionally as a positive-electrode active material for lithium-ion secondary battery, and which exhibits an irreversible capacity. For example, the following can be given: composite oxides possessing a rock-salt structure and being expressed by a compositional formula: Li₂M¹M²O₄ (where “M¹” is one or more kinds of Mg, Mn, Fe, Co, Ni, Cu and Zn; and “M²” is one or more kinds of Ti, Zr and Hf); and composite oxides possessing a layered rock-salt structure and being expressed by a compositional formula: Li₂M³O₃ (where “M³” is one or more kinds of metallic elements in which Mn is essential); and the like. It is advisable to use one kind or two or more kinds of these. These first compounds exhibit an irreversible capacity, respectively, because of their compositions and structures. In “M³,” Mn is essential, but it is possible to give metallic elements, such as Co, Ni, Ti and Zr, as an element that substitutes for Mn. As for specific examples of Li²M¹M²O₄, the following can be given: Li₂NiTiO₄, Li₂CoTiO₄, Li₂FeTiO₄, Li₂MnTiO₄, Li₂NiZrO₄, Li₂NiZrO₄, and so forth. As for specific examples of Li₂M³O₃, the following can be given: Li₂MnO₃, Li₂Mn_{0.7}Ti_{0.3}O₃, Li₂Mn_{0.95}Zr_{0.05}O₃, and so on. Note that an average oxidation number resulting from the combination of M¹ and M² is +3, whereas an average oxidation number of M³ is +4.

The second compound is not limited especially as far as it is a compound that is one of compounds having been heretofore used conventionally as a positive-electrode active material for lithium-ion secondary battery, and which is capable of absorbing more lithium than an amount of lithium that has been released at the time of first-round charging.

For example, the following can be given: composite oxides possessing a spinel structure and being expressed by a compositional formula: LiN¹₂O₄ (where “N¹” is one or more kinds of metallic elements in which Mn is essential); and composite oxides possessing a layered structure and being expressed by a compositional formula: LiN²O₂ (where “N²” is one or more kinds of metallic elements in which Ni and/or Co is essential); and the like. It is advisable to use one kind or two or more kinds of these. Although these second compounds contain one Li for one molecule in the initial state, they are capable of absorbing Li in a quantity of one or more, respectively, because of their compositions and structures. In “N¹,” Mn is essential, but it is possible to give metallic elements, such as Li, Al, Mg, Co, Ni, Ca and Fe, as an element that substitutes for Mn. As for specific examples of LiN¹₂O₄, the following can be given: LiMn₂O₄, LiMn_{1.5}Ni_{0.5}O₄, LiMn_{1.9}Al_{0.1}O₄, Li_{1.1}Mn_{0.9}O₄, LiMn_{1.5}Fe_{0.25}Ni_{0.25}O₄, and so forth. As for specific examples of LiN²O₂, the following can be given: LiMn_{0.33}Ni_{0.33}Co_{0.33}O₂. LiNiO₂, LiCoO₂, LiNi_{0.9}Mn_{0.1}O₂, and so on. Note that an average oxidation number of N¹ is +3.5, whereas an average oxidation number of N² is +3.

Note that the first compound and second compound can be those in which compounds being expressed by the above-mentioned compositional formulas make the essential composition, respectively, but shall not necessarily be limited to those, each of which has a stoichiometric composition. For example, they involve even the following, and the like: those which occur inevitably in the production to have a non-stoichiometric composition in which Li, “M¹,” “M²,” “M³,” “N¹,” “N²” or O is deficient. It is also allowable that Li can be substituted by hydrogen (H) in an amount of 60% or less, furthermore 45% or less, by atomic ratio. Moreover, although Mn is essential in Li₂M³O₃ and LiN¹₂O₄, it is even permissible that less than 55% of the Mn, furthermore less than 30% thereof, can be substituted by another metallic element or the other metallic elements. Note that it is preferable that “M¹,” “M²,” “M³,” “N¹,” and “N²” can be, even among all metallic elements, transition metal elements.

It is allowable that the positive-electrode active material according to the present invention can be a mixture including the first compound and second compound. For example, it is also permissible that, after synthesizing the first compound and the second compound separately from one another, it can be prepared as a mixed powder in which they are mixed in a powdery state. Moreover, depending on their combinations, it is even feasible to synthesize a solid solution between the first compound and the second compound. On this occasion, it is preferable that a content proportion between the first compound and the second compound can be from 1:2 to 2:1 by molar ratio. When the first compound is present excessively, as such is not preferable because the reduction effect of irreversible capacity becomes smaller. On the other hand, when the second compound is present excessively, as such is not preferable because it is not possible to efficiently make use of capacities, which the second compound is capable of absorbing, so that useless capacities have occurred.

It is suitable that the first compound and second compound are employable in potential ranges that are comparable with each other or nearly equal to one another. Descriptions will be made later on a desirable potential range in lithium-ion secondary battery.

### Lithium-Ion Secondary Battery

Hereinafter, explanations will be made on a lithium-ion secondary battery using a positive-electrode active material for lithium-ion secondary battery according to the present invention. The lithium-ion secondary battery is mainly equipped with a positive electrode, a negative electrode, and a non-aqueous electrolyte. Moreover, in the same manner as common lithium-ion secondary batteries, it is further equipped with a separator, which is held between the positive electrode and the negative electrode.

The positive electrode includes a positive-electrode active material for lithium-ion secondary battery according to the present invention, and a binding agent that binds this positive-electrode active material together. It is also allowable that it can further include a conductive additive. As for the positive-electrode active material, although it is preferable to substantially make use of the above-mentioned first compound and second compound alone, it is even permissible that both of the first compound and second compound can include one or more kinds of electrode active materials whose irreversible capacity is less, namely, one or more kinds that are selected from olivine-structured compounds, such as LiFePO₄, for instance.

Moreover, there are not any limitations especially on the binding agent and conductive additive, and so they can be those which are employable in common lithium-ion secondary batteries. The conductive additive is one for securing the electric conductivity of electrode, and it is possible to use for the conductive additive one kind of carbon-substance powders, such as carbon blacks, acetylene blacks and graphite, for instance; or those in which two or more kinds of them have been mixed with each other. The binding agent is one which accomplishes a role of fastening and holding up the positive-electrode active material and the conductive additive together, and it is possible to use for the binding agent the following: fluorine-containing resins, such as polyvinylidene fluoride, polytetrafluoroethylene and flurorubbers; or thermoplastic resins, such as polypropylene and polyethylene, and the like, for instance.

The negative electrode to be faced to the positive electrode can be formed by making metallic lithium, namely, a negative-electrode active material, into a sheet shape. Alternatively, it can be formed by press bonding the one, which has been made into a sheet shape, onto a current-collector net, such as nickel or stainless steel. Instead of metallic lithium, it is possible to use lithium alloys or lithium compounds as well. Moreover, in the same manner as the positive electrode, it is also allowable to employ a negative electrode comprising a negative-electrode active material, which can absorb/desorb lithium ions, and a binding agent. As for a negative-electrode active material, it is possible to use the following: natural graphite; artificial graphite; organic-compound calcined bodies, such as phenolic resins; and powders of carbonaceous substances, such as cokes, for instance. As for a binding agent, it is possible to use fluorine-containing resins, thermoplastic resins, and the like, in the same manner as the positive electrode.

In general, in a case where a positive electrode, which exhibits an irreversible capacity, and a negative electrode, which does not include any lithium, are employed, the unbalance between positive electrode and negative electrode that arises from an irreversible capacity of the positive-electrode active material becomes more marked. Although it is advisable to employ a negative electrode including Li, it is highly probable that Li metal undergoes the dendritic precipitation in metallic Li electrodes. It is possible for the positive-electrode active material for lithium-ion secondary battery according to the present invention to keep the balance between positive electrode and negative electrode satisfactorily in a case where materials, which do not include any Li, such as carbon-system materials like black lead or graphite, metals, such as Si and Sn, and their oxides, and the like, are employed as a negative-electrode active material.

It is common that the positive electrode and negative electrode are made by adhering an active-material layer, which is made by binding at least a positive-electrode active material or negative-electrode active material together with a binding agent, onto a current collector. Consequently, the positive electrode and negative electrode can be formed as follows: a composition for forming electrode mixture-material layer, which includes an active material and a binding agent as well as a conductive additive, if needed, is prepared; the resulting composition is applied onto the surface of a current collector after an appropriate solvent has been further added to the resultant composition to make it pasty, and is then dried thereon; and the composition is compressed in order to enhance the resulting electrode density, if needed.

For the current collector, it is possible to use meshes being made of metal, or metallic foils. As for a current collector, porous or nonporous electrically conductive substrates can be given, porous or nonporous electrically conductive substrates which comprise: metallic materials, such as stainless steels, titanium, nickel, aluminum and copper; or electrically conductive resins. As for a porous electrically conductive substrate, the following can be given: meshed bodies, netted bodies, punched sheets, lathed bodies, porous bodies, foamed bodies, formed bodies of fibrous assemblies like nonwoven fabrics, and the like, for instance. As for a nonporous electrically conductive substrate, the following can be given: foils, sheets, films, and so forth, for instance. As for an applying method of the composition for forming electrode mixture-material layer, it is allowable to use a method, such as doctor blade or bar co ater, which has been heretofore known publicly.

As for a solvent for viscosity adjustment, the following are employable: N-methyl-2-pyrrolidone (or NMP), methanol, methyl isobutyl ketone (or MIBK), and the like.

As for an electrolyte, it is possible to use organic-solvent-system electrolytic solutions, in which an electrolyte has been dissolved in an organic solvent, or polymer electrolytes, in which an electrolytic solution has been retained in a polymer, and the like. Although the organic solvent, which is included in that electrolytic solution or polymer electrolyte, is not at all one which is limited especially, it is preferable that it can include a chain ester (or a linear ester) from the perspective of load characteristic. As for such a chain ester, the following organic solvents can be given: chain-like carbonates, which are represented by dimethyl carbonate, diethyl carbonate and ethyl methyl carbonate; ethyl acetate; and methyl propionate, for instance. It is also allowable to use one of these chain or linear esters independently, or to mix two or more kinds of them to use. In particular, in order for the improvement in low-temperature characteristic, it is preferable that one of the aforementioned chain esters can account for 50% by volume or more in the entire organic solvent; especially, it is preferable that the one of the chain esters can account for 65% by volume or more in the entire organic solvent.

However, as for an organic solvent, rather than constituting it of one of the aforementioned chain esters alone, it is preferable to mix an ester whose permittivity is high (e.g., whose permittivity is 30 or more) with one of the aforementioned chain esters to use in order to intend the upgrade in discharged capacity. As for a specific example of such an ester, the following can be given: cyclic carbonates, which are represented by ethylene carbonate, propylene carbonate, butylene carbonate and vinylene carbonate; γ-butyrolactone; or ethylene glycol sulfite, and the like, for instance. In particular, cyclically-structured esters, such as ethylene carbonate and propylene carbonate, are preferable. It is preferable that such an ester whose permittivity is high can be included in an amount of 10% by volume or more in the entire organic solvent, especially 20% by volume or more therein, from the perspective of discharged capacity. Moreover, from the perspective of load characteristic, 40% by volume or less is more preferable, and 30% by volume or less is much more preferable.

As for an electrolyte to be dissolved in the organic solvent, one of the following can be used independently, or two or more kinds of them can be mixed to use: LiClO₄, LiPF₆, LiBF₄, LiAsF₆, LiSbF₆, LiCF₃SO₃, LiC₄F₉SO₃, LiCF₃CO₂, Li₂C₂F₄(SO₃)₂, LiN(CF₃SO₂)₂, LiC(CF₃SO₂)₃, or LiCₙF₂ₙ₊₁SO₃ (where “n”≧2), and the like, for instance. Among them, LiPF₆ or LiC₄F₉SO₃, and so forth, from which favorable charging/discharging characteristics are obtainable, can be used preferably.

Although a concentration of the electrolyte in the electrolytic solution is not at all one which is limited especially, it can preferably be from 0.3 to 1.7 mol/dm³, especially from 0.4 to 1.5 mol/dm³ approximately.

Moreover, in order to upgrade the safety or storage characteristic of battery, it is also allowable to make a non-aqueous electrolytic solution contain an aromatic compound. As for an aromatic compound, benzenes having an alkyl group, such as cyclohexylbenzene and t-butylbenzene, biphenyls, or fluorobenzenes can be used preferably.

As for a separator, it is allowable to use those which have sufficient strength, and besides which can retain electrolytic solutions in a large amount. From such a viewpoint, it is possible to use the following, which have a thickness of from 5 to 50 μm, preferably: micro-porous films which are made of polypropylene, polyethylene or polyolefin, such as copolymers of propylene and ethylene; or nonwoven fabrics, and the like.

A configuration of the lithium-ion secondary battery, which are constituted of the above constituent elements, can be made into various sorts of those such as cylindrical types, laminated types and coin types. Even in a case where any one of the configurations is adopted, the separators are interposed between the positive electrodes and the negative electrodes to make electrode assemblies. And, these electrode assemblies are sealed hermetically in a battery case after connecting intervals from the resulting positive-electrode current-collector assemblies and negative-electrode current-collector assemblies up to the positive-electrode terminals and negative-electrode terminals, which lead to the outside, with leads for collecting electricity, and the like, and then impregnating these electrode assemblies with the aforementioned electrolytic solution, and thereby a lithium-ion secondary battery completes.

In a case where lithium-ion secondary batteries are made use of, the positive-electrode active material is activated by carrying out charging in the first place. However, in a case where one of the above-mentioned composite oxides is used as a positive-electrode active material, lithium ions are released at the time of first-round charging, and simultaneously therewith oxygen generates. Consequently, it is desirable to carry out charging before sealing the battery case hermetically.

The above-explained lithium-ion secondary battery is chargeable and dischargeable in any of ranges from 1.3 V to 5 V with respect to lithium metal. Preferably, carrying out charging up to 4 V or more, furthermore up to 4.5 V or more, and then carrying out discharging down to less than 2 V, furthermore down to 1.4 V or less, result in decreasing the irreversible capacity. Carrying out charging up to 4 V or more, and then carrying out discharging down to less than 2 V lead to high-capacity secondary batteries that are good in the charging/discharging balance between the positive electrode and the negative electrode. In the above-described first compounds in which an irreversible capacity occurs, since many of them are compounds from which Li is less likely to leave and into which Li is less likely to enter, it is allowable to release Li forcibly by charging them up to a high potential. On the other hand, since the second compound shall comprise metallic elements whose average valence is low considerably in order to take more Li in than it does in the initial state, it is permissible to carry out discharging down to a low potential.

The lithium-ion secondary battery according to the present invention can be utilized suitably in the field of automobile in addition to the field of communication device or information-related device such as cellular phones and personal computers. For example, when vehicles have this lithium-ion secondary battery on-board, it is possible to employ the lithium-ion secondary battery as an electric power source for electric automobile.

So far, some of the embodiment modes of the positive-electrode active material for lithium-ion secondary battery and lithium-ion secondary battery according to the present invention have been explained. However, the present invention is not one which is limited to the aforementioned embodiment modes. It is possible to execute the present invention in various modes, to which changes or modifications that one of ordinary skill in the art can carry out are made, within a range not departing from the gist.

### EXAMPLES

Hereinafter, the present invention will be explained in detail while giving specific examples of the positive-electrode active material for lithium-ion secondary battery and lithium-ion secondary battery according to the present invention.

### Synthesis of Positive-Electrode Active Material

### (1-1) Synthesis of Li₂NiTiO₄

0.02-mol lithium carbonate (i.e., 1.48-gram Li₂CO₃), 0.02-mol nickel oxalate (i.e., 3.65-gram NiC₂O₄.2H₂O), and 0.02-mol titanium oxide (i.e., 1.60-gram TiO₂) were weighed out, and these were then mixed with each other while pulverizing them well with use of a mortar and pestle. The thus obtained mixture was put in an alumina boat, and was then heated within a 600° C. electric furnace in air for 12 hours. After cooling this down to room temperature and then again mixing it lightly with use of a mortar and pestle, it was put in another alumina boat and was then heat-treated within a 900° C. electric furnace in air for 12 hours, thereby obtaining an Li₂NiTiO₄ powder. Note that the thus obtained Li₂NiTiO₄ was found to have a rock-salt structure by means of X-ray diffraction measurement.

### (1-2) Synthesis of Li₂MnO₃

0.04-mol lithium hydroxide monohydrate (i.e., 1.68-gram LiOH.H₂O), and 0.01-mol manganese dioxide (i.e., 0.87-gram MnO₂) were weighed out, and these were then mixed with each other while pulverizing them well with use of a mortar and pestle. The thus obtained mixture was put in an alumina boat, and was then heated within a 500° C. electric furnace in air for 5 hours. After cooling this down to room temperature and then again mixing it lightly with use of a mortar and pestle, it was put in another alumina boat and was then heat-treated within a 800° C. electric furnace in air for 10 hours, thereby obtaining an Li₂MnO₃ powder. Note that the thus obtained Li₂MnO₃ was found to have a layered rock-salt structure.

### (2-1) Synthesis of LiMn₂O₄

0.005-mol lithium carbonate (i.e., 0.37-gram Li₂CO₃), and 0.02-mol manganese carbonate (i.e., 2.29-gram MnCO₃) were weighed out, and these were then mixed with each other while pulverizing them well with use of a mortar and pestle. The thus obtained mixture was put in an alumina boat, and was then heat-treated within a 850° C. electric furnace in air for 24 hours, thereby obtaining an LiMn₂O₄ powder. Note that the thus obtained LiMn₂O₄ was found to have a spinel structure by means of X-ray diffraction measurement.

### (2-2) Synthesis of LiMn_{0.33}Ni_{0.33}Co_{0.33}O₂

0.04-mol lithium hydroxide monohydrate (i.e., 1.68-gram LiOH, H₂O), 0.01-mol nickel hydroxide (i.e., 0.927-gram Ni(OH)₂), 0.01-mol manganese dioxide (i.e., 0.869-gram MnO₂), and 0.01-mol cobalt hydroxide (i.e., 0.930-gram Co(OH)₂) were weighed out, and these were then mixed with each other while pulverizing them well with use of a mortar and pestle. The thus obtained mixture was put in an alumina boat, and was then heated within a 500° C. electric furnace in air for 5 hours. After cooling this down to room temperature and then again mixing it lightly with use of a mortar and pestle, it was put in another alumina boat and was then heat-treated within a 850° C. electric furnace in air for 24 hours, thereby obtaining an LiMn_{0.33}Ni_{0.33}Co_{0.33}O₂ powder. Note that the thus obtained LiMn_{0.33}Ni_{0.33}Co_{0.33}O₂ was found to have a layered rock-salt structure by means of X-ray diffraction measurement.

### (3) Synthesis of Li₂MnO₃.LiMn_{0.33}Ni_{0.33}CO_{0.33}O₂ Solid Solution

0.3-mol (i.e., 12.6-gram) lithium hydroxide monohydrate, LiOH.H₂O, was mixed with 0.10-mol (i.e., 6.9-gram lithium nitrate, LiNO₃. To these, a precursor was further added in an amount of 1.0 g, thereby preparing a raw-material mixture that had a mixed phase between Li₂MnO₃ and LiCo_{1/3}Ni_{1/3}Mn_{1/3}O₂. Hereinafter, a synthesis procedure for the precursor will be explained.

0.67-mol (i.e., 192.3-gram) Mn(NO₃)₂.6H₂O, 0.16-mol (i.e., 46.6-gram) Co(NO₃)₂.6H₂O, and 0.16-mol (i.e., 46.5-gram) Ni(NO₃)₂.6H₂O were dissolved in 500-mL distilled water to make a metallic-salt-containing aqueous solution. While this aqueous solution was stirred within an ice bath using a stirrer, one in which 50-gram (i.e., 1.2-mol) LiOH.H₂O had been dissolved in 300-mL distilled water was dropped to the aqueous solution over a time period of 2 hours. Thus, the aqueous solution was alkalified, thereby precipitating deposits of metallic hydroxides. While keeping this solution holding the deposits therein at 5° C., aging was carried out for one day in an oxygen atmosphere. A precursor with Mn:Co:Ni=0.67:0.16:0.16 was obtained by means of filtering the thus obtained deposits and then washing them with use of distilled water.

The raw-material mixture was put in a crucible being made of mullite, and was then vacuum dried at 120° C. for 12 hours within a vacuum drier. Thereafter, the drier was returned back to the atmospheric pressure; the crucible, in which the raw-material mixture was held, was taken out and was then transferred immediately to an electric furnace, which had been heated to 450° C., and was further heated at 350° C. for 4 hours in an oxygen atmosphere. On this occasion, the raw-material mixture was fused to turn into molten salt, and thereby a black-colored product deposited.

Next, the crucible, in which the molten salt was held, was taken out from the electric furnace, and was then cooled at room temperature. After the molten salt was cooled fully to solidify, the solidified molten salt was dissolved in water by immersing the molten salt as being held in the crucible into 200-mL ion-exchanged water and then stirring them therein. Since the black-colored product was insoluble in water, the water turned into a black-colored suspension liquid. When filtering the black-colored suspension liquid, a transparent filtrate was obtained, and a black-colored, solid filtered substance was obtained on the filter paper. The thus obtained filtered substance was further filtered while washing it fully with use of ion-exchanged water. After vacuum drying the post-washing black-colored solid at 120° C. for 6 hours, it was pulverized using a mortar and pestle, thereby obtaining a black-colored powder.

An XRD measurement with use of the CuKa ray was carried out for the thus obtained black-colored powder. According to the X-ray diffraction measurement, it was understood that the obtained compound had a layered rock-salt structure. Moreover, according to an ICP analysis, it was ascertained that the composition was 0.5(Li₂MnO₃).0.5 (LiMn_{0.33}Ni_{0.33}Co_{0.33}O₂).

### (4) Synthesis of Li₂MnO₃.LiMn₂O₄Solid Solution

0.15-mol lithium hydroxide monohydrate (i.e., 6.3-gram LiOH.H₂O), and 0.10-mol lithium nitrate (i.e., 6.9-gram LiNO₃) were weighed out, and were then mixed with each other. To these, 0.01-mol manganese dioxide (i.e., 0.87-gram MnO₂) was added, and was further mixed one another. The thus obtained mixture was put in a crucible being made of mullite, and was then dried at 120° C. for 6 hours in a heated vacuum within a vacuum drier. Thereafter, the drier was returned back to the atmospheric pressure; the crucible, in which the mixture was held, was taken out and was then transferred immediately to an electric furnace, which had been heated to 350° C., and was further heated within the 350° C. electric furnace for 1 hour. On this occasion, salt was fused to turn into molten salt, and thereby a black-colored product deposited. After taking the crucible out from the electric furnace and then cooling the salt fully at room temperature to make it solidify, the salt was dissolved in water by immersing the salt as being held in the crucible into some 200-mL ion-exchanged water and then stirring them therein. Here, since the resulting product was insoluble in water, the water turned into a black-colored suspension liquid. When filtering the black-colored suspension liquid, a black-colored solid (i.e., a filtered substance) was obtained on the filter paper, and a transparent filtrate was obtained. The thus obtained filtered substance was further filtered while washing it fully with use of acetone, and then the obtained filtered substance (i.e., a black-colored solid) was pulverized using a mortar and pestle after vacuum drying it at 120° C. for 6 hours approximately. A powder comprising an xLi₂MnO₃.(1-x)LiMn₂O₄ solid solution was obtained by means of calcining the resulting post-drying powder at 400° C. for 1 hour in air.

### Lithium-Ion Secondary Batteries

Various lithium-ion secondary batteries were made using each of the composite oxides, which had been synthesized by the above-mentioned procedures, as a positive-electrode active material.

The following were mixed one another: any one of the positive-electrode active materials (i.e., the composite oxides) being set forth in Table 1 in an amount of 50 parts by mass; 20-part-by-mass carbon black (or KB) serving as a conductive additive; and 30-part-by-mass conductive binder (e.g., a mixture of acetylene black and polytetrafluoroethylene) serving as a binding agent (or binder), and then they were dispersed in N-methyl-2-pyrolidone serving as a solvent, thereby preparing a slurry. Subsequently, this slurry was coated onto an aluminum foil, namely, a current collector, and was then dried thereon. Thereafter, the coated aluminum foil was press rolled to 60 μm in thickness, and then the coated aluminum foil was punched out to a size of φ11 mm in diameter, thereby obtaining a positive electrode. Moreover, metallic lithium with φ14 mm and 200 μm in thickness was made into a negative electrode to be faced to the positive electrode.

Microporous polyethylene films with 20 μm in thickness serving as separators were held between the positive electrodes and the negative electrodes to make them into an electrode-assembly battery. This electrode-assembly battery was accommodated in a battery case (e.g., CR2032, a coin cell produced by HOHSEN Co., Ltd.). Moreover, a non-aqueous electrolyte, in which LiPF₆ was dissolved in a concentration of 1.0 mol/L into a mixed solvent in which ethylene carbonate and diethyl carbonate were mixed in a volumetric ratio of 1:1, was injected into the battery case, thereby obtaining a lithium-ion secondary battery.

TABLE 1

| | Mixing Ratio between Positive- | | | |
|---|---|---|---|---|
| | electrode Active Materials (molar ratio) | | | |
| | Li₂NiTiO₄ | Li₂MnO₃ | LiMn₂O₄ | LiMn₁/₃Ni₁/₃Co₁/₃O₂ |
| Comp. Ex. | 1 | None | None | None |
| No. 1 | | | | |
| Comp. Ex. | None | 1 | None | None |
| No. 2 | | | | |
| Ref. Ex. | None | None | 1 | None |
| No. 1 | | | | |
| Ref. Ex. | None | None | None | 1 |
| No. 2 | | | | |
| Ex. No. 1 | 1 | None | 1 | None |
| Ex. No. 2 | None | 1 | None | 1 |
| Ex. No. 3 | None | 1 | 0.8 | None |

Note that the positive-electrode active material according to Example No. 1 was a mixture powder of powdery compounds that had been synthesized in above-mentioned Sections (1-1) and (2-1). The positive-electrode active material according to Example No. 2, and the positive-electrode active material according to Example No. 3 were powdery solid solutions that had been synthesized in Sections (3) and (4), respectively.

### Charging/Discharging Test

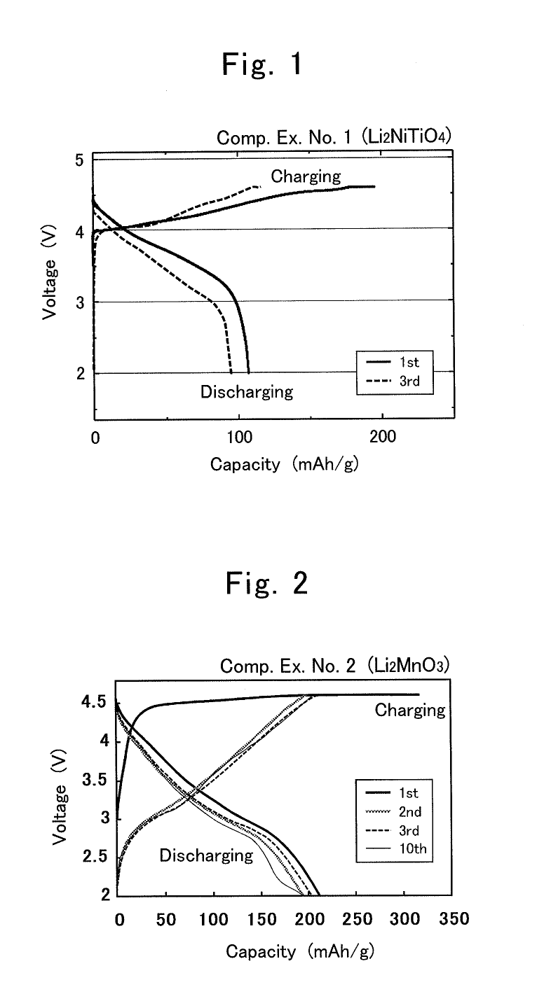

Regarding the above-mentioned lithium-ion secondary batteries, a charging/discharging test was carried out at room temperature. In the charging/discharging test, a CCCV charging (i.e., constant-current and constant-voltage charging) operation was carried out at 0.2C up to a predetermined voltage, then a CC discharging operation was carried out at 0.2C down to another predetermined voltage, and these charging and discharging operations were carried out repeatedly. Results of the charging/discharging test are illustrated in FIG. 1 through FIG. 7.

From FIG. 1, although Li₂NiTiO₄ underwent the pull out of Li up to 200 mAh/g approximately upon the charging operation from 3.5 to 4.6 V, it could discharge no more than only 100 mAh/g approximately upon the discharging operation from 4.6 to 2 V. That is, Li being equivalent to 100 mAh/g remained virtually in the negative electrode, which served as the counter electrode, so that it made an irreversible capacity. Moreover, from FIG. 2, although Li₂MnO₃ underwent the pull out of Li up to 300 mAh/g approximately upon the charging operation from 3 to 4.6 V, it could discharge no more than only 200 mAh/g approximately upon the discharging operation from 4.6 to 2 V. That is, in Comparative Example Nos. 1 and 2, Li being equivalent to 100 mAh/g remained virtually in the negative electrode, which served as the counter electrode, so that it made an irreversible capacity.

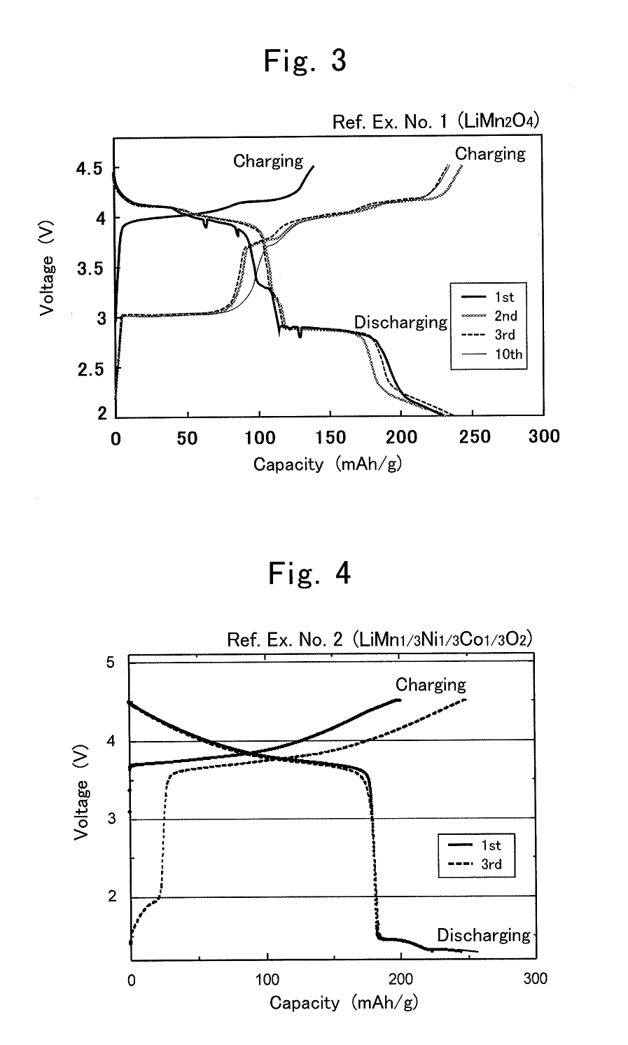

From FIG. 3, although LiMn₂O₄ only had such a capacity as 100 mAh/g approximately at the time of first-round charging operation when it underwent the charging operation from 3 to 4.5 V, it was capable of discharging that went up beyond 200 mAh/g by letting it discharge down to 3.0V or less (that is, from 4.5 to 2 V). In other words, it was understood that Li is inserted by means of discharging in an amount that is equal to or more than Li that has been released from LiMn₂O₄ by means of charging. And, it was understood that it is possible for LiMn₂O₄ to absorb Li until it turns into Li₁₊ₙMn₂O₄ (where “n” is 1 approximately).

From FIG. 4, although LiMn_{0.33}Ni_{0.33}CO_{0.33}O₂ had a capacity of no more than only 200 mAh/g approximately at the time of first-round charging when it underwent the charging operation from 3 to 4.5 V, it was capable of discharging that went up beyond 250 mAh/g by letting it discharge down to 1.5 V or less (that is, from 4.5 to 1.4 V). In other words, it was understood that Li is inserted by means of discharging in an amount that is equal to or more than Li that has been released from LiMn_{0.33}Ni_{0.33}CO_{0.33}O₂ by means of charging.

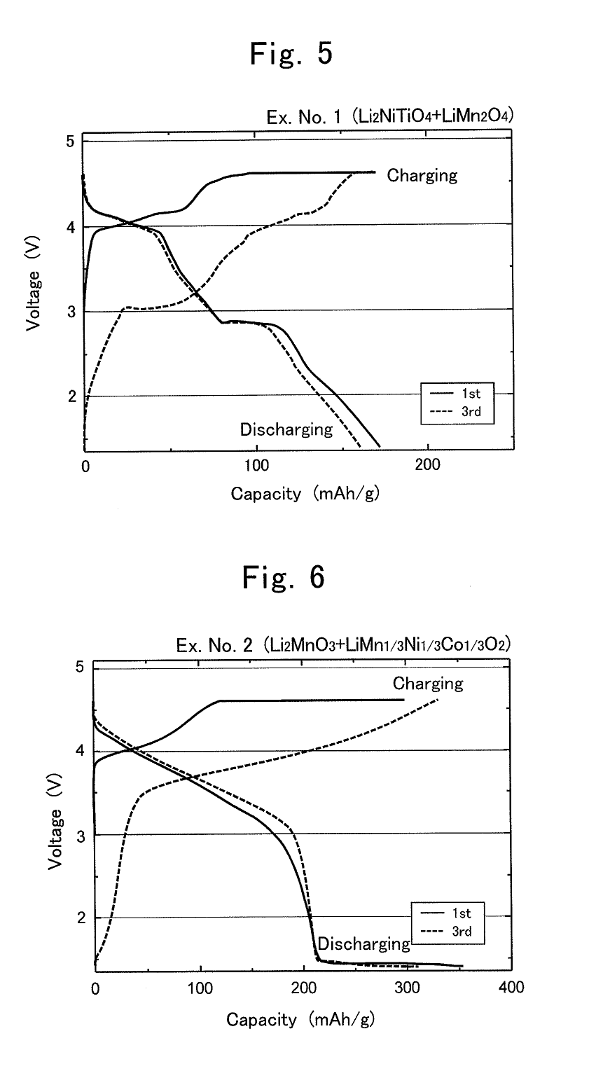

In the positive-electrode active material according to Example No. 1, Li₂NiTiO₄, which exhibited an irreversible capacity, and LiMn₂O₄ were combined to use. As having been explained already, when using Li₂NiTiO₄ independently (i.e., Comparative Example No. 1), Li, which had migrated to the counter electrode, did not come back so that the balance between the positive electrode and the negative electrode was poor. However, in Example No. 1, since LiMn₂O₄ absorbed Li by an irreversible capacity of Li₂NiTiO₄ that arose in the charging operation from 3 to 4.6 V at the first round, the discharged capacity, which was shown between 4.6 to 1.4 V immediately after the charging operation, became substantially equal to the charged capacity, as illustrated in FIG. 5. Thus, it is possible to say that the balance between the positive electrode and the negative electrode upgraded. In other words, it is presumed that Li, which has been pulled off by means of charging, comes back in an amount nearly as much as the whole amount, because it is absorbed in LiMn₂O₄ though it is not at all absorbed in Li₂NiTiO₄.

In the positive-electrode active material according to Example No. 2, Li₂MnO₃, which exhibited an irreversible capacity, and LiMn_{0.33}Ni_{0.33}CO_{0.33}O₂ were combined to use. As having been explained already, when using Li₂MnO₃ independently (i.e., Comparative Example No. 2), Li, which had migrated to the counter electrode, did not come back so that the charging/discharging balance between the positive electrode and the negative electrode was poor. However, in Example No. 2, the difference between the charged capacity and the discharged capacity that resulted from an irreversible capacity that reached 100 mAh/g approximately in Comparative Example No. 2 had been resolved completely, as illustrated in FIG. 6, by letting the lithium-ion secondary battery discharge from 4.6 down to 1.4 V after charging it from 3 to 4.6 V. In other words, it is presumed that Li, which has been pulled off by means of charging, comes back in an amount nearly as much as the whole amount, because it is absorbed in LiMn_{0.33}Ni_{0.33}Co_{0.33}O₂ though it is not at all absorbed in Li₂MnO₃. Here, the first-round discharged capacity was caused to be greater than the charged capacity because of the fact that an absorbable Li amount in LiMn_{0.33}Ni_{0.33}CO_{0.33}O₂ became greater than the irreversible capacity of Li₂MnO₃. Note that the phenomenon can be settled by setting a proportion between Li₂MnO₃ and LiMn_{0.33}Ni_{0.33}CO_{0.33}O₂ at an optimum value.

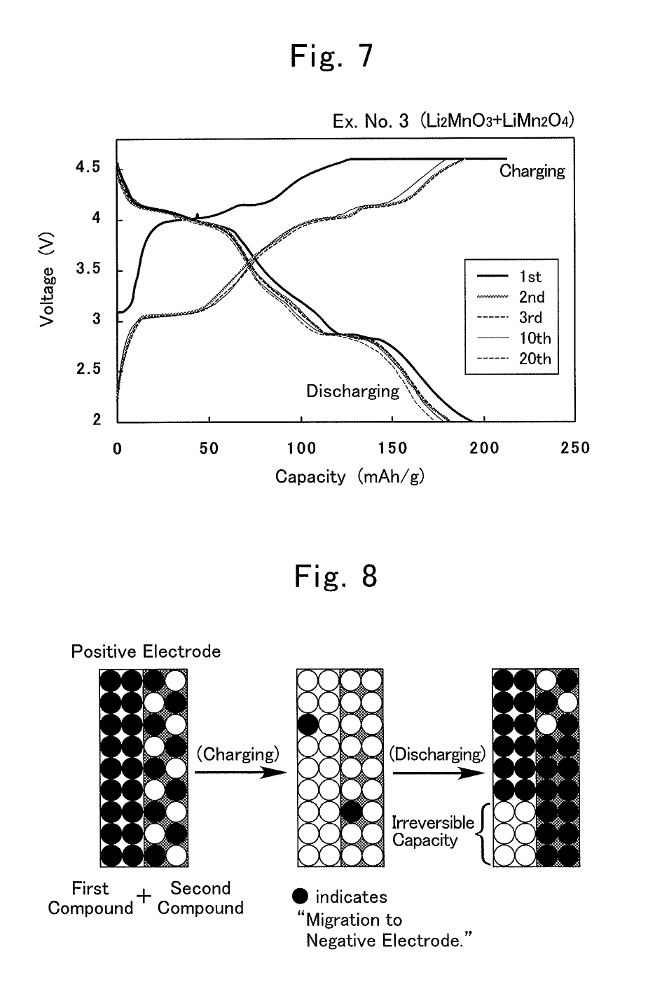

In the positive-electrode active material according to Example No. 3, Li₂MnO₃, which exhibited an irreversible capacity, and LiMn₂O₄ were combined to use. As having been explained already, when using Li₂MnO₃ independently (i.e., Comparative Example No. 2), Li, which had migrated to the counter electrode, did not come back so that the charging/discharging balance between the positive electrode and the negative electrode was poor. However, in Example No. 3, the charged capacity and the discharged capacity be came comparable with each other in the charging and discharging operations within a range of from 2.0 V to 4.6 V as illustrated in FIG. 7. In other words, it is presumed that Li, which has been pulled off by means of charging, comes back in an amount nearly as much as the whole amount, because it is absorbed in LiMn₂O₄ though it is not at all absorbed in Li₂MnO₃.

It was understood from the above that combining a first compound, which exhibits an irreversible capacity so that it does not absorb some of Li that has been released by means of charging, with a second compound, which is capable of absorbing more Li than an amount of lithium that has been released at the time of first-round charging, to make use of these as a positive-electrode active material can produce an advantageous effect of canceling the irreversible capacity of the first compound.

Note that both LiMn₂O₄ and LiMn_{0.33}Ni_{0.33}Co_{0.33}O₂ demonstrate an advantageous effect of acting on compounds exhibiting irreversible capacities to reduce the irreversible capacities. Such an advantageous effect can be demonstrated not only to Li₂NiTiO₄ and Li₂MnO₃ alone, but also to compounds as well that have irreversible capacities and are used in the same extent of voltage range as LiMn₂O₄ and LiMn_{0.33}Ni_{0.33}CO_{0.33}O₂ are used.

1. A positive-electrode active material for lithium-ion secondary battery being characterized in that:
it is a positive-electrode active material for lithium-ion secondary battery, the positive-electrode active material being capable of absorbing and releasing lithium;
it includes the following at least: a first compound exhibiting an irreversible capacity; and a second compound being capable of absorbing more lithium than an amount of lithium that has been released at the time of first-round charging; and
it exhibits an irreversible capacity decreasing as a whole of active material.

2. The positive-electrode active material for lithium-ion secondary battery as set forth in claim 1, wherein said second compound is one or more kinds being selected from the group consisting of:
composite oxides possessing a spinel structure, and being expressed by a compositional formula: LiN¹₂O₄ (where “N¹” is one or more kinds of metallic elements in which Mn is essential); and
composite oxides possessing a layered structure, and being expressed by a compositional formula: LiN²O₂ (where “N²” is one or more kinds of metallic elements in which Ni and/or Co is essential).

3. The positive-electrode active material for lithium-ion secondary battery as set forth in claim 1, wherein said first compound is one or more kinds of the following:
composite oxides possessing a rock-salt structure, and being expressed by a compositional formula: Li₂M¹M²O₄ (where “M¹” is one or more kinds of Mg, Mn, Fe, Co, Ni, Cu and Zn, and “M²” is one or more kinds of Ti, Zr and Hf).

4. The positive-electrode active material for lithium-ion secondary battery as set forth in claim 1, wherein:
said first compound is Li₂NiTiO₄; and
said second compound is LiMn₂O₄ possessing a spinel structure.

5. The positive-electrode active material for lithium-ion secondary battery as set forth in claim 1, wherein:
said first compound is one or more kinds being selected from the group consisting of composite oxides possessing a rock-salt structure, and being expressed by a compositional formula: Li₂M¹M²O₄ (where “M¹” is one or more kinds of Mg, Mn, Fe, Co, Ni, Cu and Zn, and “M²” is one or more kinds of Ti, Zr and Hf); and composite oxides possessing a layered rock-salt structure, and being expressed by a compositional formula: Li₂M³O₃ (where “M³” is one or more kinds of metallic elements in which Mn is essential); and
said second compound is one or more kinds being selected from the group consisting of composite oxides having a layered structure, and being expressed by a compositional formula: LiN²O₂ (where “N²” is one or more kinds of metallic elements in which Ni and/or Co is essential).

6. The positive-electrode active material for lithium-ion secondary battery as set forth in claim 5, wherein:
said first compound is Li₂MnO₃; and
said second compound is LiMn_{1/3}Ni_{1/3}Co_{1/3}O₂.

7. The positive-electrode active material for lithium-ion secondary battery as set forth in claim 1, the positive-electrode active material absorbing, of lithium that has been released at the time of first-round charging, at least some of the lithium, which is equivalent to the irreversible capacity of said first compound, at the time of subsequent discharging.

8. The positive-electrode active material for lithium-ion secondary battery as set forth in claim 1, the positive-electrode active material being capable of charging and discharging in any of ranges from 1.3 V to 5 V by potential with respect to lithium metal, and being employed under such a charging/discharging condition that charging up to 4 V or more and discharging down to less than 2 V are carried out.

9. The positive-electrode active material for lithium-ion secondary battery as set forth in claim 1, wherein a content proportion between said first compound and said second compound is from 1:2 to 2:1 by molar ratio.

10. The positive-electrode active material for lithium-ion secondary battery as set forth in claim 1, wherein said first compound, and said second compound form a solid solution.

11. A lithium-ion secondary battery being characterized in that it is equipped with:
a positive electrode including the positive-electrode active material for lithium-ion secondary battery as set forth in claim 1;
a negative electrode; and
a non-aqueous electrolyte.

12. The lithium-ion secondary battery as set forth in claim 11, wherein said positive-electrode active material for lithium-ion secondary battery is capable of charging and discharging in any of ranges from 1.3 V to 5 V by potential with respect to lithium metal, and carries out charging up to 4 V or more and discharging down to less than 2 V.

13. The lithium-ion secondary as set forth in claim 11, wherein said negative electrode includes a negative-electrode active material comprising a carbon-system material or metallic lithium.

14. A vehicle being characterized in that it has the lithium-ion secondary battery as set forth in claim 11 on-board.
